(19) United States
(12) Patent Application Publication
(10) Pub. No.: US 2014/0335614 A1
(43) Pub. Date: Nov. 13, 2014

(54) METHOD AND DEVICES FOR CRYOPRESERVATION OF BIOMATERIALS

(71) Applicant: Biocision, LLC, Mill Valley, CA (US)

(72) Inventor: Brian Schryver, Redwood City, CA (US)

(21) Appl. No.: 14/366,395

(22) PCT Filed: Dec. 21, 2012
(86) PCT No.: PCT/US2012/071108

§ 371 Date: Jun. 18, 2014

Related U.S. Application Data
(60) Provisional application No. 61/578,800, filed on Dec. 21, 2011.
(60) Provisional application No. 61/602,457, filed on Feb. 23, 2012.

(51) Int. Cl. G01N 1/42; F25D 31/00

(52) U.S. Cl. CPC G01N 1/42; F25D 31/006
USPC 435/374

(57) ABSTRACT

Improved methods for cryopreservation of cells result when cells are cooled at controlled rates in devices that ensure a constant rate of cooling of less than 10° C.

### BACKGROUND OF THE INVENTION

A wide variety of laboratory tests and assays utilize living cells, tissues, and biomolecules prepared from them (collectively “biomaterials”), including biomaterials that have been maintained in a frozen state and then “thawed” for use in the assay or test of interest. “Cryopreservation” refers to the freezing of biomaterials, particularly living cells and tissues in a manner that retains cell viability (or some other desired property of a biomaterial). See Mazur, Am. J. Physiol. 247 (Cell Physiol. 16): C125-C142 (1984), incorporated herein by reference. The science of cryopreservation can be characterized as in an early stage of development; however, it is generally believed by practitioners that a variety of factors can reduce cell viability and other properties of biomaterials after cryopreservation, including the rate at which the biomaterials are frozen. Many cryopreserved biomaterials are stored in freezers designed to maintain temperatures in the range of −70° C. to −86° C. Such freezers are often referred to as −80° C. freezers, because they are set to maintain that temperature, although other set temperatures, such as −75° C., the temperature of dry ice, are not uncommon.

There are only a few products on the market today that purportedly provide a controlled cooling rate. Generally, a “cooling rate” refers the rate at which a reference substance loses heat when placed in an environment that is colder than the ambient temperature of the reference substance. The cooling rate of biomaterials in commercially available tubes and vials when placed in dry ice or a −80° C. freezer is generally very fast. Because the rate of cooling influences post thaw viability of many biomaterials, biomaterials freezing processes are frequently monitored and recorded, i.e., the temperature of the biomaterial is recorded as a function of time during the freezing process. The plot of such information is termed a “freezing curve”. The freezing curve typically exhibits a number of phases. For a cell-based sample, the first phase is the initial time point until the time point at which ice forms in the extracellular space (when the sample reaches the “nucleation temperature”). Immediately after nucleation, there is an increase in temperature due to the release of the latent heat of fusion. Some studies and protocols describe a cooling rate as the slope of the temperature versus time plot in the region shortly before nucleation through −50° C. Some studies have suggested that the lower the nucleation temperature, the lower the post-thaw survival.

Most commercially available tubes, vials, and holders of tubes and vials (commonly referred to as “racks”) provide very rates of cooling (i.e., cool faster than −10° C. per minute) for samples at or above room temperature that are placed in dry ice or a −80° C. freezer. Moreover, for most commercially available racks, the actual rate of cooling depends on the number of tubes or vials in the rack and their location in the rack. Use of such racks necessarily implies that biomaterials in different tubes or vials will be subjected to different cooling rates.

A notable exception to this general rule regarding cooling rates for commercially available tubes, vials, and racks is the CoolCell® product line of BioCision, LLC. This product line includes freezing devices for the controlled, alcohol-free cooling of samples. The freezing devices are constructed out of highly durable cross-linked high-density polyethylene foam comprising a heat transfer system that is either an inner heat sink compartment with a solid core or ventilation holes at the top and bottom of the freezing device (see U.S. patent application Ser. Nos. 12/819,024, 61/487,445; and 61/527,649; and PCT patent application 2011/040757 [Pub. No. 2011/159934], each of which is incorporated herein by reference). The product line includes: #BCS-136 and #BCS-170 that respectively hold up to twelve and up to thirty 1.8 mL (2 mL nominal) or 1.2 mL cryovials; #BCS-172 that holds twelve 2 mL serum vials; #BCS-171 that holds twelve 4.5 (5 mL nominal) cryovials; and #BCS-262 that holds six 10 mL serum vials. These products provide, when fully loaded with cryovials having a liquid load of 1 mL, a cooling rate of 1° C./minute when placed in a −75° C. environment (e.g., a mechanical freezer or dry ice locker), where the “cooling rate” is defined as the average slope of a temperature versus time graph of the temperature of a fluid contained in a sample vial (and rack, if present) that is at a temperature of 20° C. at time zero, the time at which the sample vial (and rack, if present) is placed into a −75° C. environment, to the time at which the sample is cooled to −0° C.

There remain significant unmet needs, however, in cryopreservation. Many cell types still exhibit significantly reduced viability after cryopreservation, and there is growing evidence that many cell types, even those that appear to have high viability after cryopreservation, undergo phenotypic changes as a result of cryopreservation, making assays and tests based on them less reliable. Similar variability problems exists with other biomaterials after cryopreservation. Thus, there remains a need for methods and devices for cryopreservation of biomaterials that reduce variability among cryopreserved samples. The present invention addresses such unmet needs by providing methods for the cryopreservation of cells and devices for practicing those methods.

### SUMMARY OF THE INVENTION

In some implementations, the present invention provides methods for determining the optimal cooling rate (unless otherwise indicated, “cooling rate” as used herein refers to the “standard cooling rate”: the average slope of a temperature versus time graph of the temperature of the biomaterial, which may be in a vial or tissue culture plate, which in turn may be in a freezing device, where the biomaterial and any vial, plate, and/or freezing device are at a temperature of 20° C. at time zero, the time at which the freezing device is placed into a −75° C. environment, to the time at which the biomaterial is cooled to 0° C.). Generally, the method involves the steps of freezing samples of the biomaterial at different cooling rates, thawing the samples, and testing the samples for a desired property. In various embodiments, the biomaterial is a sample of cells, and the desired property is cell viability. In various embodiments, the different cooling rates are rates between 0.01° C. to 10° C. per minute, e.g., the cooling rates are selected from the group consisting of 0.25° C. per minute, 0.5° C. per minute, 1° C. per minute, 2° C. per minute, 3° C. per minute, and 5° C. per minute.

In other implementations, the present invention provides methods for the cryopreservation of biomaterials. Generally, the methods involve the step of freezing the biomaterial at a controlled cooling rate under 10° C. per minute. In some embodiments, the cooling rate is 0.5° C. per minute, 2° C. per minute, and 3° C. per minute. In other embodiments, the biomaterials are cells. In various embodiments, the cells are selected from the group consisting of [list cell types of interest here, in alphabetical order].

Further, in some implementations the present invention provides freezing devices that provide predetermined controlled cooling rates and so are referred to as “static freezing devices”. In some embodiments, a cooling device provides a cooling rate of 0.5° C. per minute. In other embodiments, a cooling device provides a cooling rate of 1° C. per minute. Further, in some embodiments a cooling device is provided having a cooling rate of 2° C. per minute.

In other implementations, the present invention provides a freezing device that can provide any of a variety of different controlled cooling rates as selected by the user of the device and so are referred to as “programmable freezing devices”. In some embodiments, the freezing device provides programmable cell freezing and thawing, including different cooling rates ranging from 0.01° C. per minute to 3° C. per minute. In other embodiments, all of the vials or other sample containers (e.g. well in a multi-well plate) in the device are cooled (or thawed or both) at the same rate. In other embodiments, different vials or sample containers in the device are cooled (or thawed or both) at different rates. The cooling rate can be programmed to be constant or variable. The device can be operated in a multi-well format, in which either a microtiter (96 well) plate or other multi-well plate is placed in the device, and the device is operated in any of a variety of formats selected by the user. In some embodiments, different cooling and/or thawing rates are tested in a multi-well format simultaneously (i.e., one or more wells are tested at one rate while other wells are tested at another rate simultaneously). In other embodiments, the device is equipped to provide a read-out for cell viability (e.g., based on a colorimetric assay using a reagent such as trypan blue or alamar blue) or cell function.

These and other aspects and embodiments of the invention are described in more detail below.

### BRIEF DESCRIPTION OF THE DRAWINGS

FIG. 1 shows an embodiment of a vial freezing device of the invention that provides a cooling rate of 2° C. per minute when loaded with six sample vials containing 1 ml of freezing medium per vial, where the “cooling rate” is defined as (the “standard cooling rate definition”). The device assembly 100 comprises an insulating base container 110 with six chambers for receiving the sample vials 130. A central cavity of the base contains a thermoconductive alloy core ballast 120 of such length that a protruding portion of the core also interfaces with the insulating lid 140 and secures the lid in position by means of a friction fit.

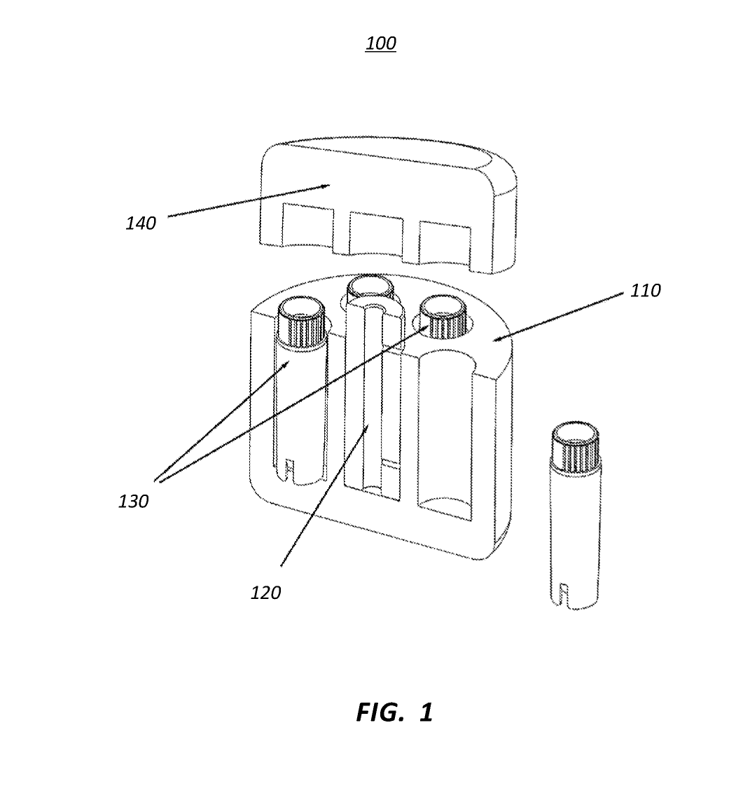

FIG. 2 shows the dimensions of the 2° C. per minute freezing or cooling device shown in FIG. 1, in accordance with a representative embodiment of the present invention. The cylindrical base and lid both have a diameter of 2.75 inches with a base height of 2.17 inches and a lid height of 1.040 inches. The central receptacle has a diameter of 0.625 inches. The base central well and vial receptacles have a depth of 1.73 inches, and the lid central receptacle and vial receptacles have a depth of 0.44 inches. The vial receptacles have a diameter of 0.6 inches and are positioned in a radial pattern 0.81 inches from the cylindrical axis, with a uniform angular distribution of 60 degrees.

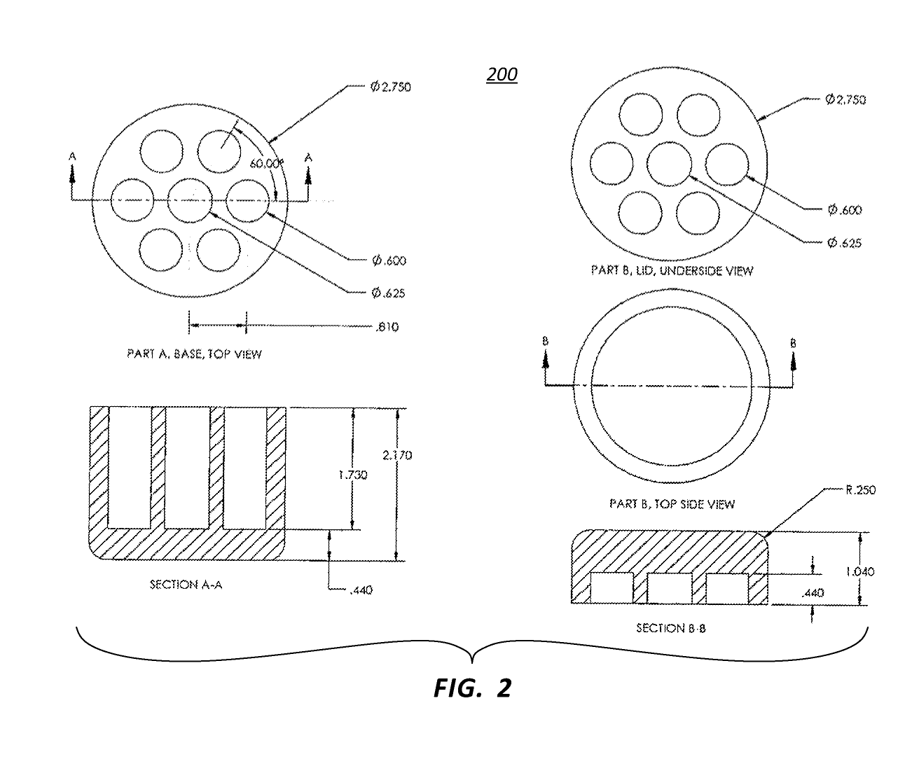

FIG. 3 shows the dimensions of the alloy core ballast for the 2° C. per minute freezing device of the invention shown in FIGS. 1 and 2. The ballast has a cylindrical tubular shape with a height of 2.13 inches, an outside diameter of 0.620 inches, and an inside diameter of 0.2 inches. Two horizontal ports connecting the outside of the cylinder with the interior space are positioned 0.4 inches from either end of the cylinder such that an air pressure relief is created at the interface of the lid and base of the freezer regardless of how the core is inserted into the base. The core ballast is constructed from an aluminum alloy.

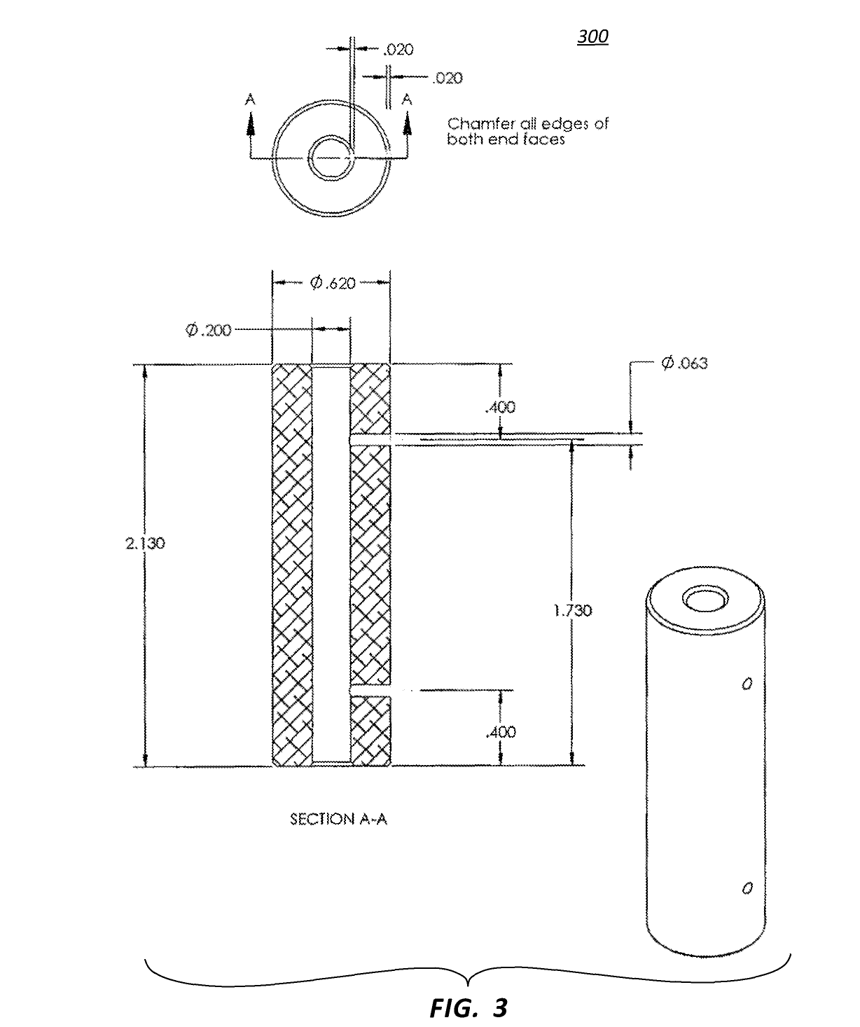

FIG. 4 shows an embodiment of a vial freezing device of the invention that provides a cooling rate, using the standard cooling rate definition, of 1° C. per minute when loaded with twelve sample vials containing 1 ml of freezing medium per vial. The device assembly 400 comprises an insulating base container 410 with twelve chambers for receiving the sample vials 430. A central cavity of the base contains a thermoconductive alloy core ballast 420. The lid 440 comprises a plug extension 450 that interfaces with the central cavity of the base thereby securing the lid in position.

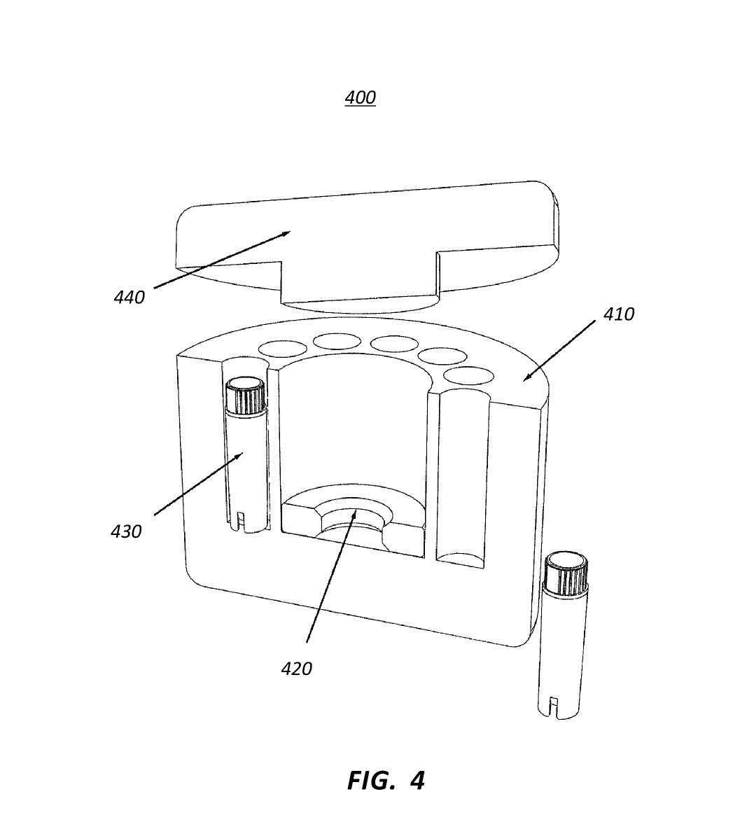

FIG. 5 shows the dimensions of the 1° C. per minute freezing device shown in FIG. 4, in accordance with a representative embodiment of the present invention. The cylindrical base and lid both comprise a diameter of 4.625 inches with a base height of 3.175 inches and a lid height of 0.75 inches. The central receptacle cavity has a diameter of 1.9 inches. The base central well and vial receptacles have a depth of 2.175 inches. The lid has a plug extension with a height of 0.5 inches that interfaces with the central cavity, thereby securing the lid. The vial receptacles are 0.6 inches in diameter and are arranged in a radial pattern 1.4 inches from the axis of the cylindrical base with an angular separation of 30 degrees.

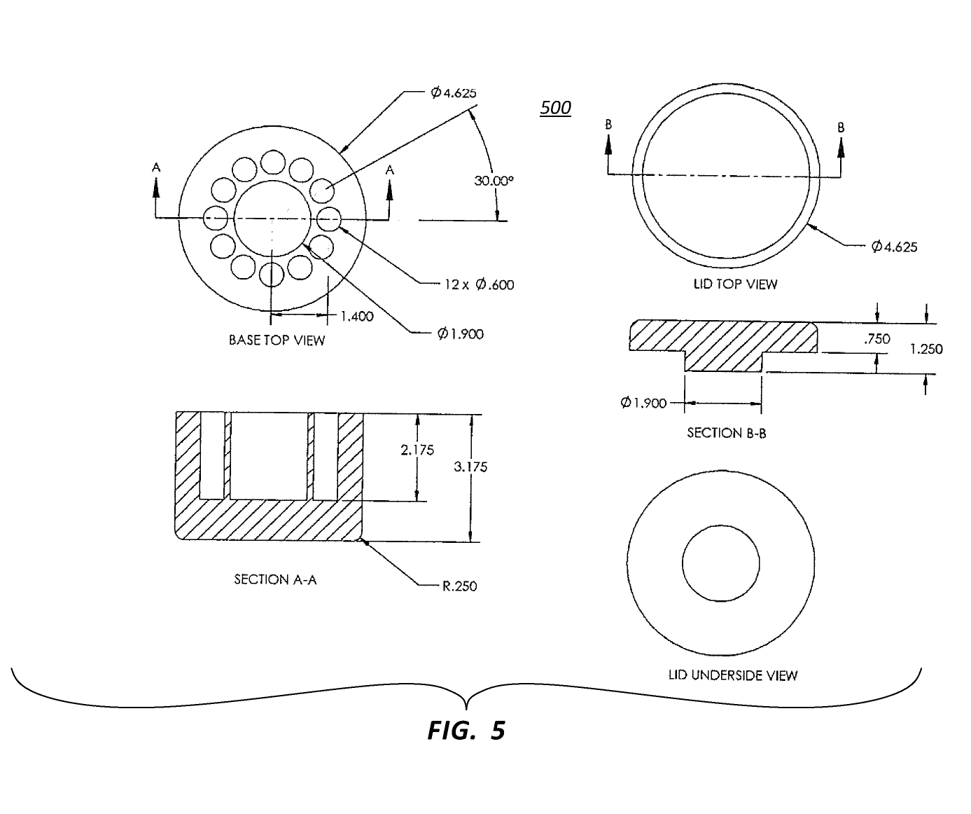

FIG. 6 shows the dimensions of the alloy core ballast for the 1° C. per minute freezing device shown in FIGS. 4 and 5. The ballast is a flat ring shape with a height of 0.4 inches, an outside diameter of 1.88 inches and an inside diameter of 0.8 inches. The core ballast is constructed from an aluminum alloy.

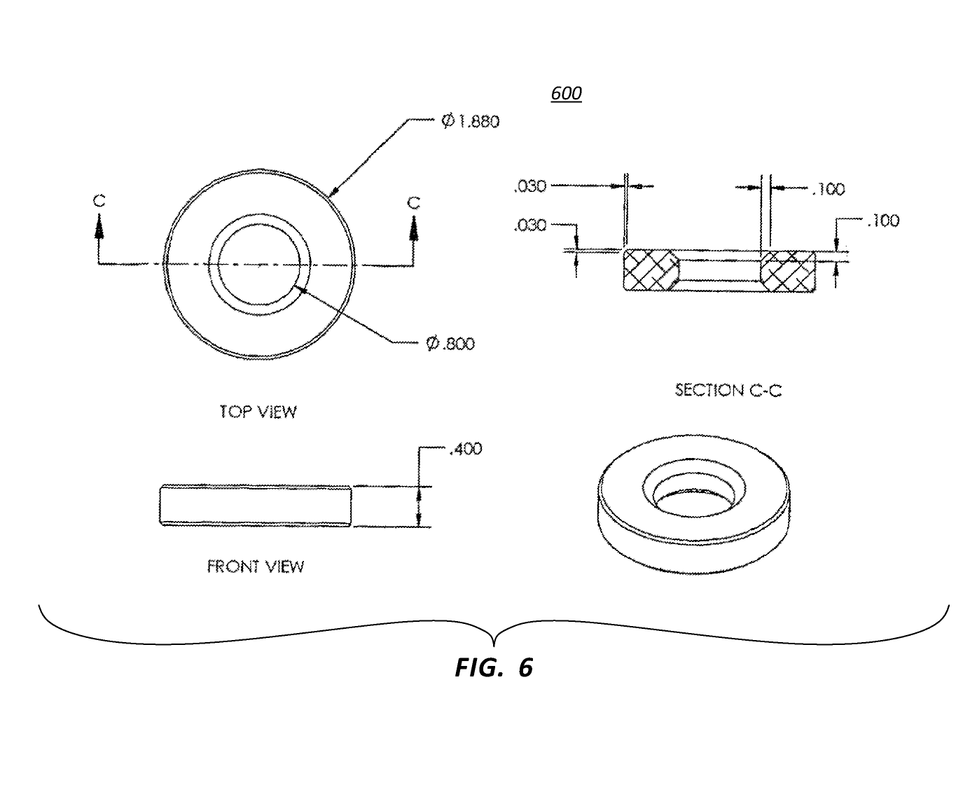

FIG. 7 shows an embodiment of a vial freezing device of the invention that provides a cooling rate, using the standard cooling rate definition, of 0.5° C. per minute when loaded with twelve sample vials containing 1 ml of freezing medium per vial. The device assembly 700 comprises an insulating base container 710 with six chambers for receiving the sample vials 730. A central cavity of the base contains a thermoconductive alloy core ballast 720 of such length that a protruding portion of the core also interfaces with the insulating lid 740 and secures the lid in position by means of a friction fit. Four foot extensions 750 serve to reduce thermal exchange with the supporting surface.

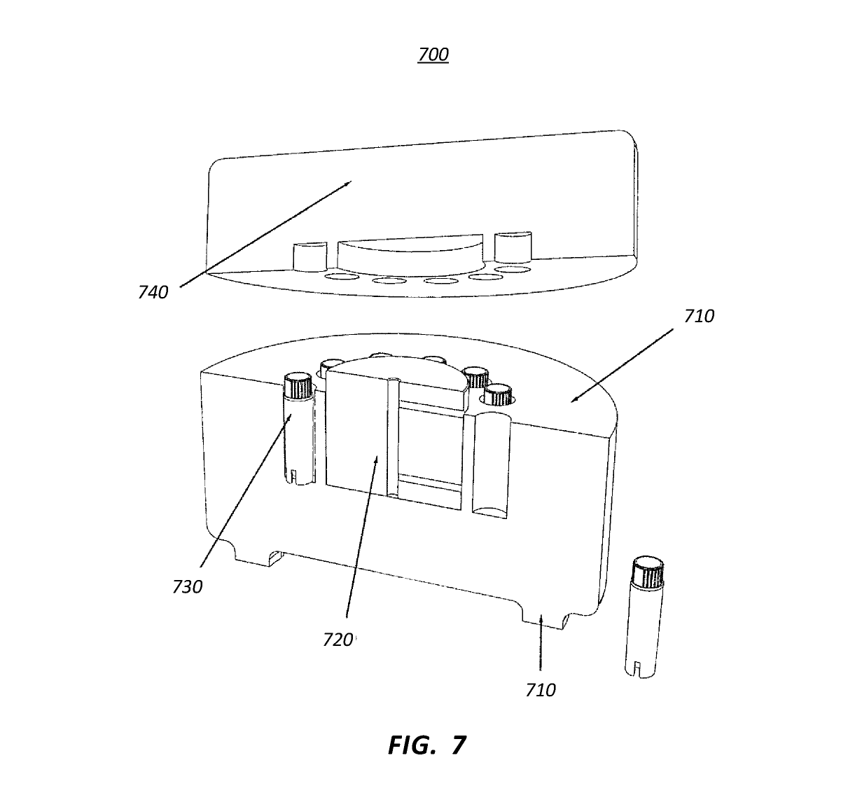

FIG. 8 shows the dimensions of the base of the 0.5° C. per minute freezing device shown in FIG. 7, in accordance with a representative embodiment of the present invention. The cylindrical base comprises a diameter of 7.350 inches with a base height of 3.23 inches. The central receptacle has a diameter of 2.5 inches. The base central well and vial receptacles have a depth of 1.73 inches. Four extension feet with a height of 0.35 inches elevate the body of the base above the supporting surface. The twelve vial receptacles have a diameter of 0.6 inches and are spaced in a radial pattern 1.75 inches from the central axis of the base with an angular separation of 30 degrees.

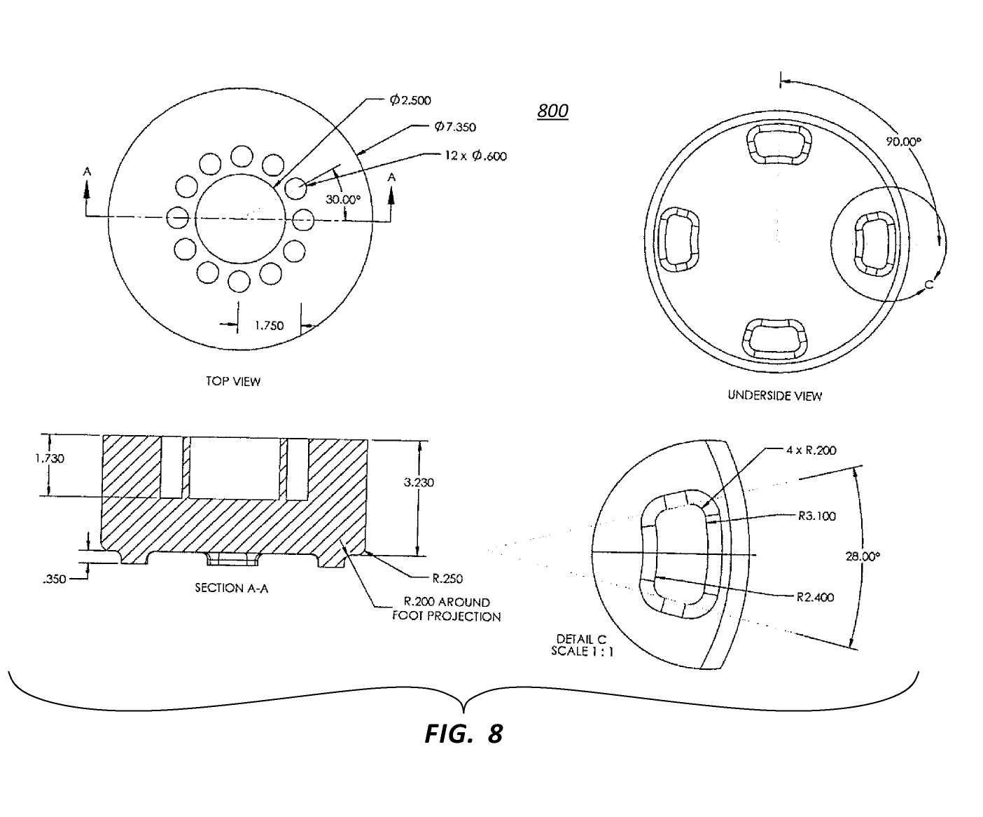

FIG. 9 shows the dimensions of the lid component for the freezing device shown in FIGS. 7 and 8. The cylindrical lid has a diameter of 7.350 inches with a height of 2 inches. The central receptacle cavity has a diameter of 2.5 inches. The central well and vial receptacles have a depth of 0.44 inches. The twelve vial receptacles have a diameter of 0.6 inches and are arranged in a radial pattern 1.75 inches from the central axis of the lid with an angular separation of 30 degree intervals.

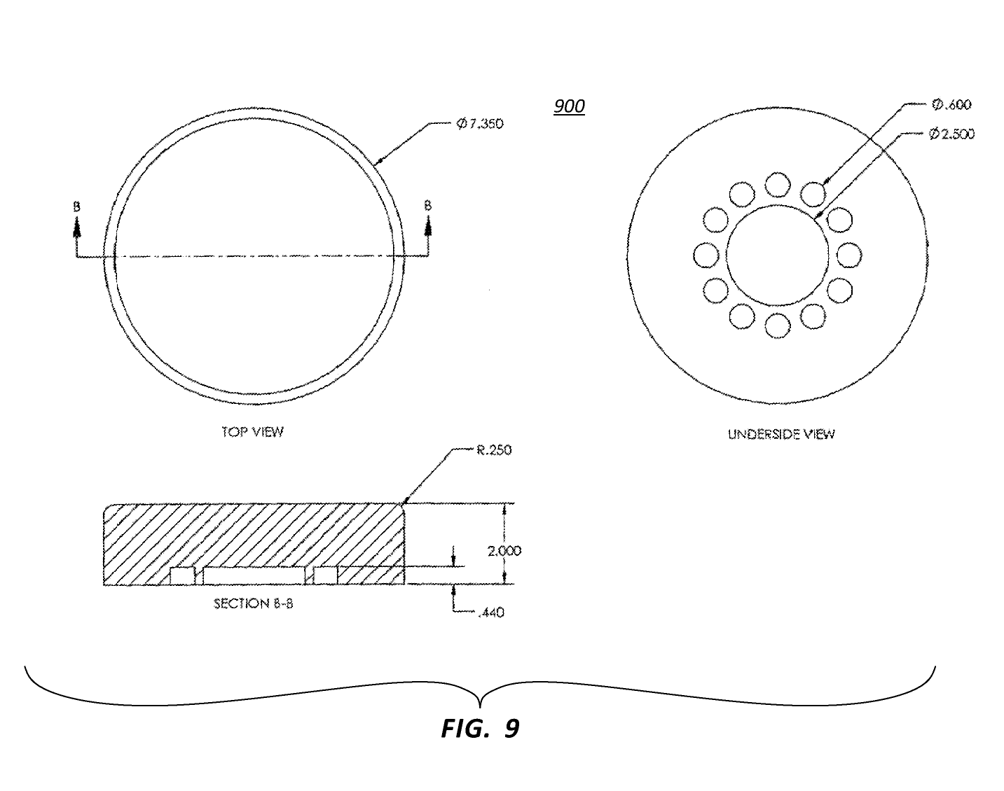

FIG. 10 shows the dimensions of the alloy core ballast of the 0.5° C. per minute vial freezing device shown in FIGS. 7 and 8, in accordance with a representative embodiment of the present invention. The ballast has a cylindrical tubular shape with a height of 2.13 inches, an outside diameter of 2.5 inches, and an inside diameter of 0.2 inches. Two horizontal ports connecting the outside of the cylinder with the interior space are positioned 0.4 inches from either end of the cylinder such that an air pressure relief is created at the interface of the lid and base of the freezer regardless of how the core is inserted into the base. The core ballast is constructed from an aluminum alloy.

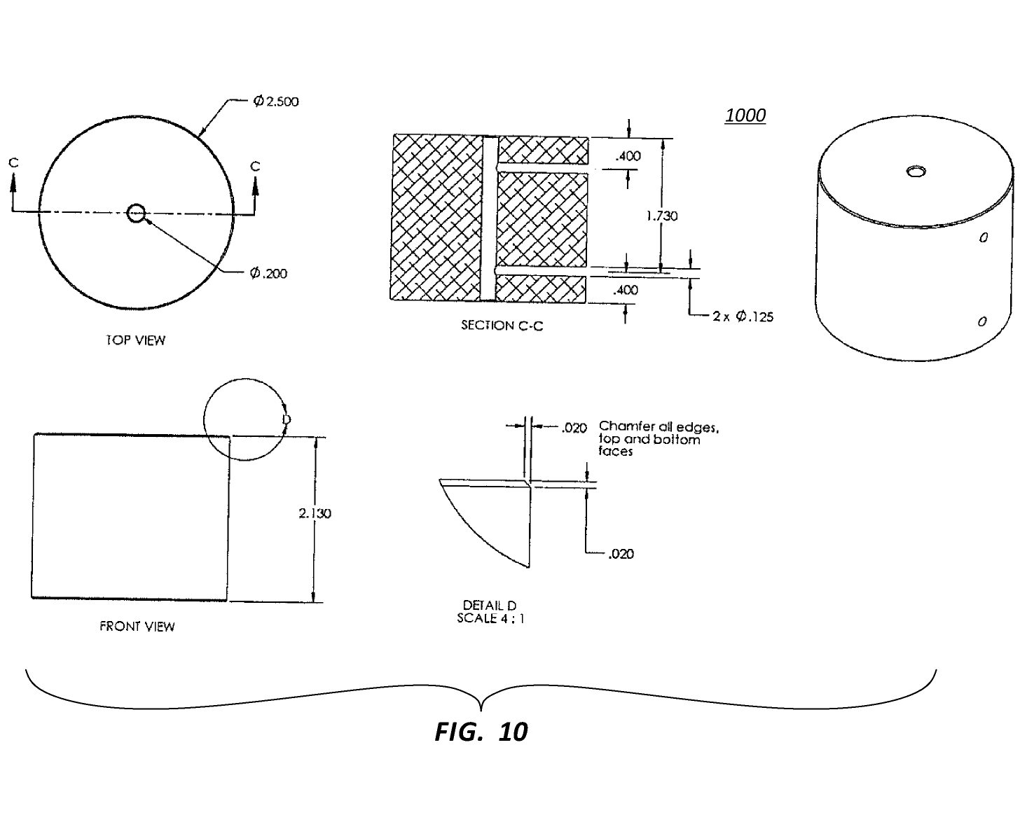

FIG. 11 shows consistent cooling temperature profiles of various cooling devices (i.e. CoolCell® devices) when placed in a −80° C. freezer in accordance with various representative embodiments of the present invention.

FIG. 12 demonstrates cell viability of 293T cells following various freeze/thaw cycles using a cooling device in accordance with a representative embodiment of the present invention.

FIG. 13 demonstrates cell viability of HUVEC cells following various freeze/thaw cycles using a cooling device in accordance with a representative embodiment of the present invention.

FIG. 14 demonstrates Capase 3/7 signal activity in HUVEC cells during various freeze/thaw cycles using a cooling device in accordance with a representative embodiment of the present invention.

### DETAILED DESCRIPTION OF THE INVENTION

The present invention relates generally to methods and devices for achieving optimal freezing of biomaterials. The present invention arises in part from the discovery that different types of biomaterials have different optimal cooling rates for cryopreservation, where optimal is defined relative to the purpose for which the biomaterial is being subjected to cryopreservation. For example, in some instances cells are often frozen such that they may be thawed and used later in assays or tests, in which case it is important that the cryopreservation process maximizes cell viability and minimizes phenotypic alterations of the cells due to cryopreservation. Moreover, while the prior art generally teaches that the optimal cooling rate for biomaterials is 1° C. per minute, the present invention arises in part from the discovery that the optimal cooling rate actually varies from biomaterial to biomaterial, including from cell type to cell type, and with respect to the purpose for which the biomaterials are being subject to cryopreservation.

The present invention accordingly has a variety of aspects and embodiments generally relating to methods for determining the optimal cooling rate, methods for the cryopreservation of biomaterials, and devices that provide a pre-set cooling rate, including “static” devices designed to provide a specific cooling rate under certain specified conditions and “programmable” devices that can be programmed by the user to provide any of a number of different cooling (and thawing) rates.

### I. Methods for Determining the Optimal Cooling Rate of a Biomaterial

In some embodiments, the invention provides methods for determining the optimal cooling rate of a biomaterial. In one embodiment, the biomaterial is cell or population of cells, where “population of cells” includes not only cells of all or substantially all of one cell type but also populations of mixed cell types, including but not limited to tissue, i.e., organ or tumor, samples, and devices for performing those methods. The invention also provides methods for the cryopreservation of cells and other biomaterials in which the cooling rate has been determined in accordance with this invention and devices for performing the methods of the invention.

In some embodiments, a method for determining an optimal cooling temperature for the cryopreservation of a biomaterial such as a cell or population of cells generally comprises the steps of cooling multiple samples of said biomaterial such as a cell or population of cells at multiple cooling rates in the range of from 0.01° C. to 10° C. per minute from a temperature of less than 37° C., e.g. 20° C., to a temperature of −75° C.; maintaining said samples at −75° C. for a period of at least 10 minutes to a period of several days or longer; thawing (e.g. warming) said samples to a temperature of at least about 20° C. to at least about 37° C.; measuring a property of the biomaterial, e.g., if the biomaterial is living cells, then the property could be the viability of the cells, as determined by measuring the number of viable cells in the thawed sample; and determining the optimal cooling rate by identifying the sample with the optimal activity, e.g., if the biomaterial is living cells, determining the sample with the most viable cells. In variations of this aspect of the invention, in addition to or in place of viability, another property (e.g. a phenotypic trait of cells, activity of an enzyme, binding affinity of an antibody) of the biomaterial is measured to determine the optimal cooling rate.

In various embodiments, these methods for determining an optimal cooling rate for a sample in a vessel, can comprise: dividing the sample into at least a part A and a part B; placing part A in a vessel A; placing part B in a vessel B; placing vessel A in a freezing device A, wherein the combination of vessel A and freezing device A provides a cooling rate A; placing vessel B in a freezing device B, wherein the combination of vessel B and freezing device B provides a cooling rate B, wherein cooling rate B is different from cooling rate A; and determining whether cooling rate A or cooling rate B is the optimal cooling rate. In some embodiments, the vessel is a tube or vial. In other embodiments, the vessel is a well of a multi-well plate.

The cooling rate of a sample is determined by plotting the temperature of the sample during cooling against time. Such plotting provides a freezing profile for the sample. The freezing profile can consist of a first near-linear temperature drop phase, followed by a phase change plateau during which the temperature of the sample remains relatively constant or decreases at a slower rate than the initial temperature drop rate, followed by a second rapid temperature drop phase. Unless otherwise indicated, the cooling rate is the average slope of a temperature versus time graph of the temperature of the biomaterial, which may be in a vessel, as described herein, which in turn may be in a freezing device, where the biomaterial and any vial, plate, and/or freezing device are at a temperature of 20° C. or higher at time zero, the time at which the freezing device is placed into a −75° C. environment, to the time at which the biomaterial is cooled to 0° C.

While “sample”, as used herein, refers to a biomaterial and optionally non-biological materials associated therewith, typically a sample will include one or more living cells. Thus, samples typically include biomaterials such as human cells, non-human cells or organisms, human or mammalian tissues and tissue samples, cancer cells, and tumor tissue. Samples include cell lines, primary tissue cells, dendritic cells, stem cells, yeast cells, E. coli cells, blood cells (e.g., lymphocytes, red blood cells), tissue samples, tumor samples, biological specimens, PBMC, primary cells, transformed cell lines, hybridomas, and engineered cell lines, including recombinant cell lines that express a heterologous gene product. Samples thus often include compounds and compositions characteristic of cells, e.g., monosaccharides, oligosaccharides, polysaccharides, lipids, phospholipids, glycolipids, sterols, glycerolipids, hormones, neurotransmitters, vitamins, amino acids, polypeptides, proteins, enzymes, metabolites, secondary metabolites, nucleotides, polynucleotides, nucleic acids (e.g., DNA, RNA), and other natural products (e.g., isoprenoids).

Dividing the sample into identical parts may be done by aliquoting (e.g., of a liquid sample), dissecting (e.g., of a solid sample), or any other process that generates multiple similar or identical parts of a sample.

The term “vessel” as used herein refers to any vessel that comprises a compartment in which a sample may be placed and a cover with which to seal the compartment, and that can sustain the temperature to which the sample is to be cooled. A suitable vessel includes but is not limited to a serum vial (e.g., a Daikyo Seiko Crystal Zenith® (CZ) vial) and a cryogenic vial (as, for example, obtainable from Sigma-Aldrich, Inc., St. Louis, Mo.; product numbers CLS320289, CLS430658, CLS430659, CLS430661, CLS430662, CLS430663, CLS430487, CLS430488, CLS43049, CLS430490, CLS430491, CLS430492, CLS430656, V9255, V9380, V8130, and many more). Vessels may hold, for example and without limitation, a volume of 1 mL, 1.2 mL, 2 mL, 3 mL, 4 mL, 5 mL, 10 mL, 15 mL, or 25 mL. The vessel may be manufactured from polypropylene, polyethylene, glass, specialized polymers, or any other suitable material. The top of the vessel may comprise an internal or external thread for attachment of the cover, and a silicon washer or O-ring for a leak-proof seal, or may be hermetically sealed by heat fusion of the vessel opening. The bottom of the vessel may be conical or round or any other shape. The compartment and/or the cover of the vessel may be clear, opaque, or solidly colored.

Different cooling rates can be achieved by placing multiple samples in different vessels; then, the different vessels can be placed in the same freezing device (same cooling environment). The present invention provides devices for practicing this embodiment of the invention. Thus, any of the currently marketed BioCision CoolCell products can be used to provide a cooling rate of 1° C. per minute, and the devices provided herein can be used to provide cooling rates of, for example and without limitation, 0.5 and 2° C. per minute (cooling environment is a −80° C. freezer set at −75° C. or dry ice). Collectively, these devices enable the practitioner to determine an optimal freezing rate for a cell of either 0.5, 1 or 2° C. While the absolute optimal rate may be other than one of these three rates, improved cryopreservation will nonetheless result when the optimal rate of among these three rates is used for cryopreservation. Thus, in one embodiment of the method, the optimal cooling rate is the cooling rate determined as optimal among a set of different cooling rates.

### II. Methods for the Cryopreservation of Biomaterials

In some embodiments, the present invention provides methods for the cryopreservation of biomaterials, including but not limited to cells. In some embodiments, the method comprises cooling said biomaterials, such as cells to a temperature of −75° C. or lower at a rate under 10° C. per minute. In other embodiments, the rate is slower than 10° C. per minute but faster than 1° C. per minute. In some embodiments, the rate is 2° C. per minute. In other embodiments, the rate is slower than 1° C. per minute. In some embodiments, the rate is 0.5° C. per minute.

In various embodiments, the optimal cooling rate for a sample of biomaterial, such as a cell population, was determined in accordance with the first aspect of this invention, e.g. by placing multiple identical or substantially similar samples in a multitude of identical vessels, which are then separately placed in different freezing devices (which may be discrete devices or may be different wells of a device capable of cooling at multiple different cooling rates simultaneously) that achieve different cooling rates when placed in the same cooling environment. In some embodiments, the different cooling rates achieved by the different freezing devices are selected from the group consisting of cooling rates of 0.5° C./minute, 1° C./minute, 1.5° C./minute, 2° C./minute, 3° C./minute, 4° C./minute, 5° C./minute, 6° C./minute, 7° C./minute, 8° C./minute, 9° C./minute, and 10° C./minute.

A cooling environment may be any environment that has a lower temperature than the sample. Examples of cooling environments include but are not limited to a mechanical freezer, a dry ice locker, a dry ice/ethanol bath, a container filled with liquid nitrogen, a container filled with nitrogen vapor, and a −80° C. freezer.

An optimal cooling rate for a sample is a cooling rate that provides maximal preservation of a characteristic of interest of a sample following cooling/freezing, storage, and warming/thawing of the sample. Examples of such characteristics include but are not limited to cell viability, cell health, stage of cell differentiation, expression of an endogenous or a heterologous gene, tissue morphology, and cell morphology. In some embodiments, the optimal cooling rate is the cooling rate that maximally preserves post-thaw cell viability. The term “cell viability” as used herein refers to the percentage of living cells in a sample. In other embodiments, the optimal cooling rate is the cooling rate that maximally preserves post-thaw cell health. In some embodiments, the optimal cooling rate is the cooling rate that maximally preserves post-thaw tissue or cell morphology. In other embodiments, the optimal cooling rate is the cooling rate that maximally preserves post-thaw expression of a heterologous gene by a cell.

Maximal preservation of a characteristic of interest of a sample of a biomaterial following cooling/freezing, storage, and warming/thawing may be determined by any suitable method. The optimal cooling rate for preserving post-thaw cell health may be determined, for example, by examining cellular and sub-cellular organelle morphologies by microscopy (e.g., electron microscopy). The optimal cooling rate for preserving post-thaw cell viability may be determined, for example, by suspending the cells in growth medium, incubating for a defined period of time, harvesting the cells, and determining the number of viable cells by counting cells not stained by trypan blue or alamar blue in a heamocytometer. Alternatively, post-thaw viability can be determined by plating efficiency (see, for example, Harris and Griffiths (1974) Cryobiology 11:80-84), resazurin assay, or propidium iodide staining. The optimal cooling rate for preserving post-thaw state of cell differentiation may be determined, for example, by staining the cells using specific markers and probes. The optimal cooling rate for preserving post-thaw expression of heterologous gene may be determined, for example, by Western blot analysis of cell sample extracts. In each determination, the characteristic of interest of the post-thaw cells is compared to that of unfrozen cells and/or to that of cells frozen in the various freezing devices. Preservation of the characteristic of interest may be determined immediately after thawing of the sample, or at any time point after such thawing, e.g., after ten minutes, 1 hour, 12 hours, 24 hours, 48 hours, 62 hours, 7 days, or longer, i.e., at any time point after thawing.

As those of skill in the art will appreciate upon contemplation of this disclosure, a cooling rate that may be optimal with regard to one characteristic may not be optimal with regard to another characteristic. In some embodiments, the optimal cooling rate maximally preserves just one characteristic of a sample. In other embodiments, the optimal cooling rate maximally preserves more than one characteristic of a sample.

Thus, in one aspect, the invention provides a method for freezing a sample at a cooling rate other than 1° C./minute, the method comprising placing a sample in a freezing device that when loaded with the sample achieves a cooling rate other than 1° C./minute when placed in a cooling environment. A cooling rate other than 1° C./minute may be any cooling rate, including but not limited to 0.25° C./minute, 0.5° C./minute, 1.5° C./minute, 2° C./minute, 3° C./minute, 4° C./minute, 5° C./minute, 6° C./minute, 7° C./minute, 8° C./minute, 9° C./minute, and 10° C./minute. A cooling rate other than 1° C./minute may be achieved by placing the vessel comprising the sample in a freezing device that provides such other cooling rate.

In some aspects, the sample frozen in accordance with the present invention is a sample of living cells. Thus, the present invention provides methods for the cryopreservation of cells. In some embodiments, the cells are hematopoietic stem cells (HSCs), including but not limited to human umbilical cord blood (UCB)-derived hematopoietic progenitor and CD34+ stem cells. In other embodiments, the cells are human embryonic stem cells (hESCs), including but not limited to cells from hESC lines H1, H9, Shef3 and Shef6. In some embodiments, the methods are carried out in a passive cooling device of the invention. In various embodiments, the cells are cryopreserved using a cooling rate selected from the group consisting of 0.5° C./min, 1° C./min, 2° C./min, 5° C./min, 7° C./min, and 9° C./min. In some embodiments, the cells are cryopreserved in a cryoprotecant mixture that contains 10% DMSO and fetal calf serum. In other embodiments, the cells are cryopreserved in a cryoprotect and mixture that contains no animal derived material and/or less than 10% (including no) DMSO. In some embodiments, the methods and devices provide, relative to other methods and devices, a significant increase in recovery of total nucleated cells and CD34⁺ cell yield from cord blood-derived HSCs post thaw.

Thus, in one aspect, the invention provides cryopreservation protocols for both hematopoietic stem cell transplant and for human embryonic stem cells, optionally using xeno-free cryoprotectants with minimal or no DMSO. The invention provides a significant improvement in all cell therapies that require cell cryopreservation, including but not limited to Hematopoietic Stem Cell Transplantation (HSCT) for the treatment of malignant and non-malignant hematological diseases, including leukemia, anemia and immunodeficiency. The availability of a robust, easy to use and economical freezing device for allogeneic cell therapies generally, and umbilical cord blood-derived HSCT in particular, dramatically increases access to this life-saving intervention.

Availability of a DMSO-free xeno-free cryoprotectant greatly simplifies the post-thaw handling of HSCs for transplant and significantly improve safety by avoiding patient adverse reactions to both DMSO and Dextran 40, which is currently required to remove the CPA from hematopoietic stem cell preparations (such as Hemacord), a procedure which contributes to further loss of critical CD34+ and other progenitor cell counts prior to infusion. Furthermore, both fundamental research into and clinical application of hESCs could be expanded dramatically with the availability of a robust, standardized, reproducible, and economical methods and devices of the invention that provide consistent quality control metrics and optimal recovery rates of cryopreserved stem (and other) cell lines.

Interest in the research and therapeutic application of hematopoietic stem cells has increased since the first successful transplant using umbilical cord-derived cells was performed on a child with Fanconi's Anaemia in 1988 (Gluckman, 1989). Stem cells used in research and for therapeutic applications are frozen, or cryopreserved, for extended times between cell harvesting and their ultimate use. Current strategies require cryopreservation of HSC progenitor cells for virtually all autologous and many allogeneic transplants and so an essential pre-requisite to the commercial and clinical application of hematopoietic and other stem cells are effective standardized cryopreservation protocols and the subsequent long-term storage of cryopreserved cells. This is particularly true for HSCs from umbilical cord blood, which are harvested at birth but used for transplantation much later. For stem cell therapy applications, there are thousands of frozen stem cell units stored in public and private repositories for later use in research or clinical applications.

Cell cryopreservation involves harvesting the cells, addition of cryopreservative, and freezing of cells, most commonly by cooling the cells slowly, under either passive or controlled rate freezing, and subsequent storage either in a mechanical −80° C. freezer, or at −160° C. in liquid nitrogen. Cells are thawed, and CPA is removed prior to use. Slow cooling of cell suspensions proceeds by a two-stage mechanism [Mazur 1984, Baust 2009]. In the first cooling stage, heat is removed from the cell suspension until it reaches a temperature where ice crystals form outside the cell. Formation of extracellular ice results in an increase in the solution electrolyte concentration. In the second cooling stage, water is removed from the cell by osmosis, resulting in an increase in cell electrolyte concentration. In some embodiments, success of the freezing procedure is critically dependent on the rate of cell freezing. If freezing is too slow, prolonged exposure to multimolar intracellular concentrations results in cell toxicity, leading to cell necrosis and apoptosis post thaw. If freezing is too rapid, the cell is unable to lose water quickly enough to maintain chemical equilibrium between intra- and extracellular water. The cell then becomes supercooled and intracellular ice forms. This can result in cell death by cell rupture and early-stage necrosis and apoptosis that occurs over the first few hours after the cell is thawed. The thawing process is also important, and consensus holds that it should be as rapid as possible [Baust 2009].

Formation of intracellular ice traditionally is suppressed by addition of cryopreservation agents (CPAs) to the cell suspension before it is frozen [Hunt 2011]. The CPA most commonly used is dimethylsulfoxide (DMSO) at a 10% v/v concentration. However, DMSO is known to be toxic [Berz 2007], and must be removed prior to cell infusions by various procedures involving a two-stem elution in the presence of Dextran [Rubenstein 1995]. This acts as an osmotic buffer that prevents damaging osmotic transients during the removal of the CPA, and helps to remove granulocyte debris which reduces adverse reactions in the recipient. Procedures that use automated cell-washing devices have been developed [Berz 2007, Woods 2007]. Because DMSO is known to be toxic, and that toxicity is time and temperature dependent, many alternative CPA formulations have been developed. There is little adverse effect on cell recovery or engraftment in reducing DMSO concentrations to 5% for cooling rates that are considered “optimal” [Mazur 2004]. Concentrations as low as 2% have been employed successfully [Berz 2007], and alternative cryopreservates such as hydroxyethyl starch (HES) and trehalose, either in combination with DMSO [MCullough 2010] or alone [Buchanan 2004] have been shown to be effective in cryopreservation of hematopoietic stem cells. However, there has been no effort to date to optimize combinations of CPAs with differential cooling rates for stem cell cryopreservation.

Devices used for slow cooling range from vials plunged into freezing-point-lowered ice baths, to alcohol-assisted coolers (“Mr. Frosty”, Nalgene), both of which have poor temperature profile control and reproducibility, to costly electronically controlled-rate freezers. While controlled-rate coolers offer major advantages in this regard, their use within the broader research community is limited by their cost (about $20K), their need for a liquid nitrogen coolant, and mechanical reliability issues. An alternative to methods that use slow cooling of cell solutions is vitrification of cells in liquid nitrogen. Vitrification avoids ice formation but uses much higher CPA concentrations (8.2M) than required for slow cooling. For stem cells, these high CPA levels can cause uncontrolled differentiation and lowered viability [Hegner 2005]. The procedure is labor intensive, uses small sample sizes (0.1-10 μl), and therefore is not conducive to larger scale cryopreservation required for many research and most cell therapeutic applications, where tens of milliliters must be processed at a time.

The present invention provides a family of passive cooling devices that can achieve cooling rates from 0.5° C./min to 9° C./min when placed in a standard −80° C. freezer, and combine cell-specific freezing rate data with cryoprotectants (CPAs) that result in optimized viability and growth characteristics post-recovery. The present invention arises in part from the discovery that differing cooling rates are required for different cell lines, due to differences in cell size, cell wall elasticities and permeabilities, and sensitivity to cryopreservatives.

By integrating the optimal cryopreservant with a robust passive cooling device that reproducibly freezes standard cryovials at a predefined and tightly-controlled rate, the methods and devices of the invention significantly increase post-thaw viable cell yield with optimal growth characteristics for a given cell line or primary cell type. Practice of the invention can significantly reduce variability from experiment to experiment, treatment to treatment, and from site to site. More effective cryopreservation protocols have several benefits in UCB transplantation: because engraftment is related to the CD34⁺ cell dosage transplanted, optimizing CD34⁺ yield reduces the constraints imposed by the low absolute progenitor cell count per unit of CB. This avoids the need for ex vivo expansion to compensate for cell losses, and avoids adverse reactions due to DMSO/Dextran removal. Efficient cryopreservation of hESC lines allows the generation of master and working cell banks such that consistent, quality-controlled stocks of cells are available for in vitro studies and/or clinical use. Current hES differentiation protocols are complex and expensive, so cryopreserving stocks ensures that only high-quality, well-characterized hESCs are taken forward through differentiation and safety testing before clinical applications.

In some embodiments, the methods of the invention are practiced with a currently marketed passive cooling device, the CoolCell® (BioCision, CA) device, which enables highly consistent, alcohol-free cooling of biological samples. The CoolCell device is made of high-density polyethylene foam that surrounds up to twelve standard 1.5 ml cryovials, and the unit is closed with an insulating lid that interlocks with the base unit. The CoolCell unit is designed to freeze cells at a controlled rate of 1° C./min when placed into a −80° C. mechanical freezer. Cells are cooled by transferring heat from the sample vials to the outside environment, and the inner heat sink compartment that is made of a solid thermally conductive material serves to adjust the duration of the fusion phase of the freezing profile.

In some instances, a key innovative feature of the CoolCell device compared to conventional passive cooling devices, such as isopropanol-based units, is that the CoolCell device provides a highly consistent cooling profile. Freezing profiles of the CoolCell device are reproducible and reflect that, where initially the sample is cooled at a rate of 1° C./min, the temperature then plateaus while the latent heat is removed, and thereafter the temperature again follows a 1° C./min cooling rate until it approaches thermal equilibrium with the freezer.

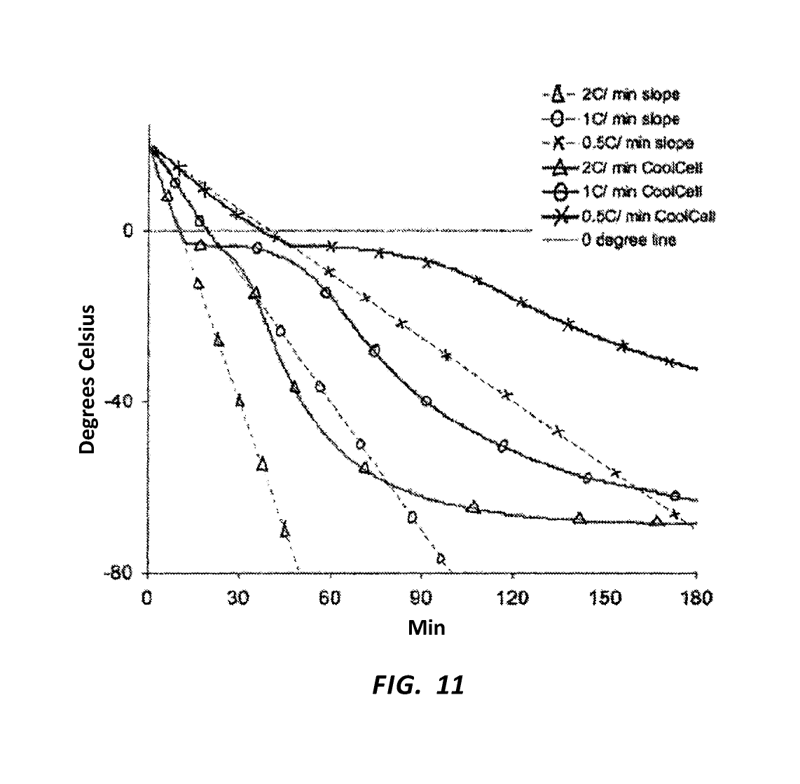

In accordance with the invention, different cells are best cryopreserved by matching cell type with the cooling rate, and in some embodiments, rates other than the “standard” of 1° C./min are preferred for some cell types. Accordingly, the present invention provides various cooling devices that can freeze cells at rates faster and slower than the accepted “standard.” Data for the temperature profiles on representative cooling devices of the present invention having cooling rates of 0.5° C./min and 2° C./min are shown in FIG. 11, along with a standard 1° C./min model. Note the excellent fit of the initial cooling profile to the design specification.

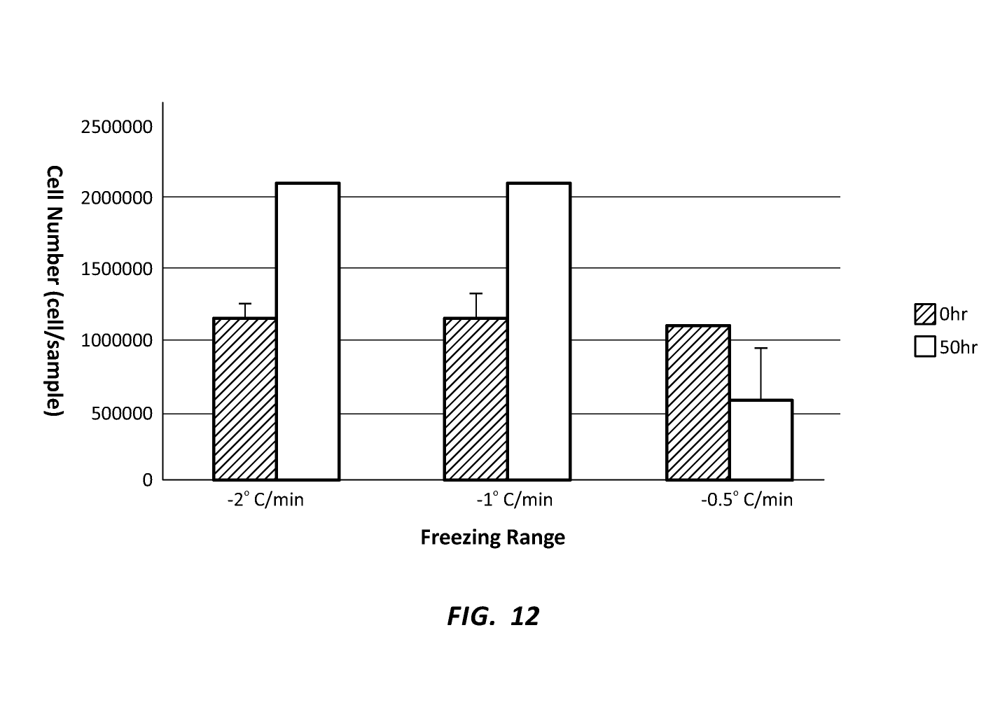

In some instances, the cooling devices of the present invention demonstrate superior cell viability when frozen at a faster freezing rate, as shown in FIG. 12. FIG. 12 shows the results of an experiment that was performed to determine the effects of freezing rates on 293T cells. Three aliquots of one million 293T cells were frozen in three individual cryovials in 1 mL of a cryopreservative agent (CPA) comprising 90% FBS/10% DMSO. The three vials of cells were each placed into a cooling device of the present invention having a freezing rate of −0.5° C./minute, −1.0° C./minute, or −2° C./minute. The cooling devices and cryovials were then placed into a −80° C. freezer. After freezing, the cells were thawed and cultured in 293T complete media. The number of cells was measured at 0 hours and then again at 50 hours.

For the cells that were frozen in the −0.5° C./minute cooling device, severe cell death was observed. However, cell viability determined by live cell number was significantly better for the cells that were frozen at the faster freezing rates of −1° C./minute and −2° C./minute.

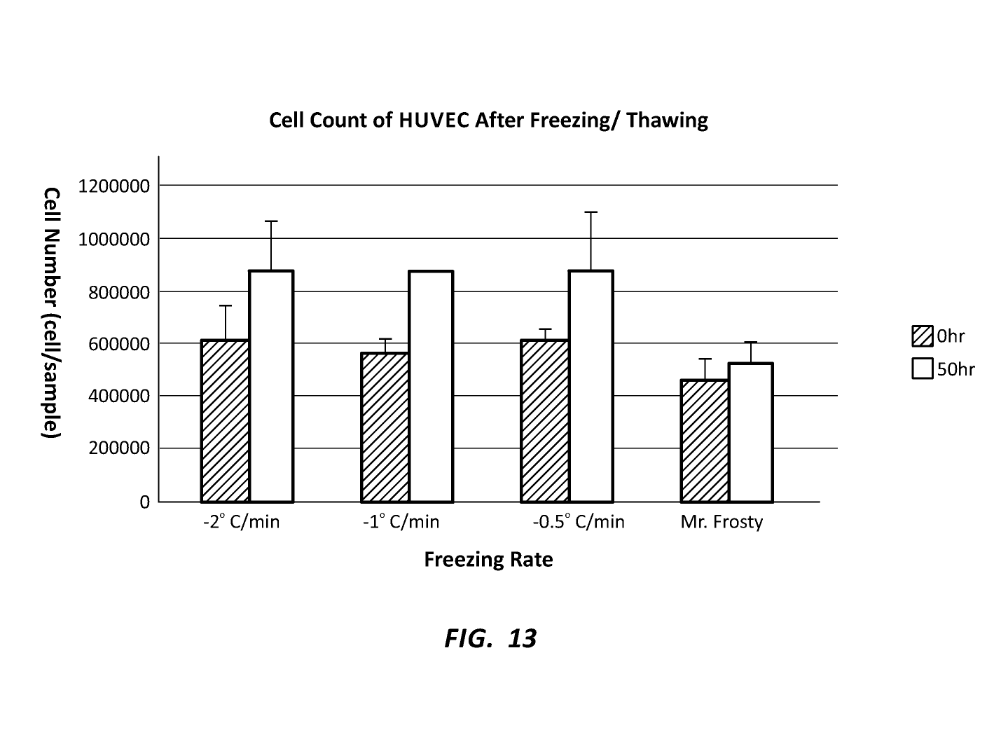

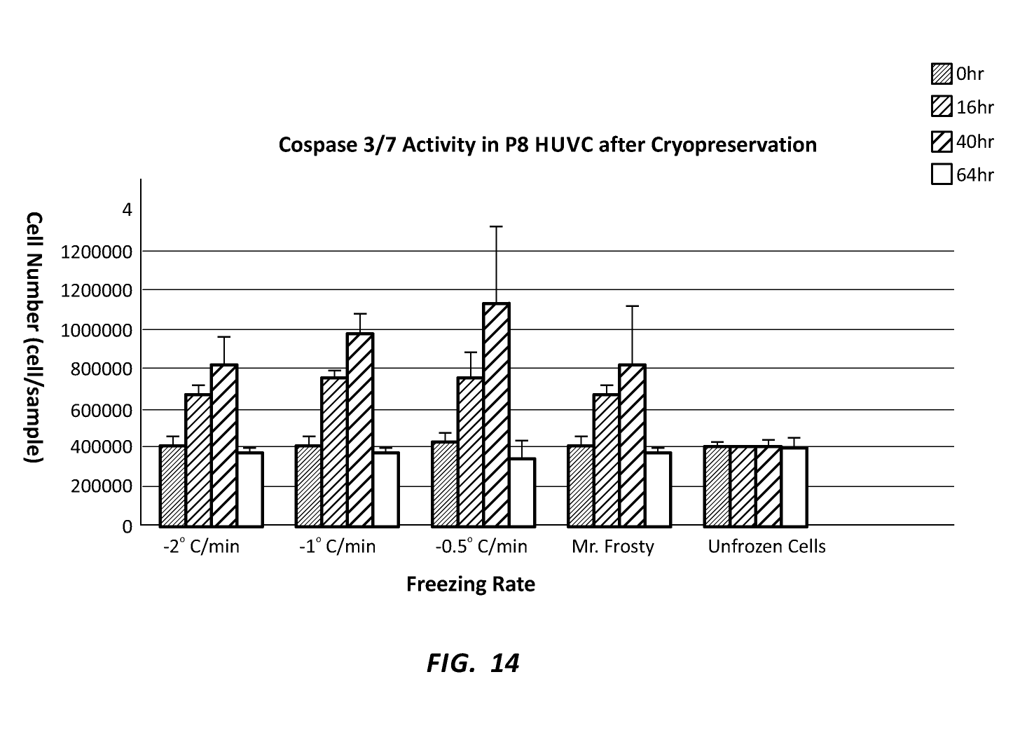

In some instances, cells frozen in cooling devices of the present invention can be recovered with greater cell yield and viability, as compared to standard passive freezing device (Mr. Frosty, Nalgene). Referring now to FIGS. 13 and 14, the results of a freeze/thaw experiment are shown which demonstrate the superior viability of cells that are frozen using the cooling devices of the present invention. Four aliquots of half a million (5×10⁵) HUVEC cells were frozen in four individual cryovials in 1 mL of CPA comprising 50% IMDM+40% FBS+10% DMSO. Three of the vials of cell were each placed into a cooling device of the present invention having a freezing rate of −0.5° C./minute, −1.0° C./minute, or −2° C./minute. The fourth vial of cells was placed into a Mr. Frosty freezing device. All of the vials and their respective cooling devices were then placed into a −80° C. freezer. After freezing, the cells were thawed and cultured in HUVEC complete media for three days before harvesting. In addition to viable cell counts (the results of which are shown in FIG. 13), Caspase 3/7 values were determined for each vial of HUVEC cells at 0, 16, 40, and 64 hours to determine cellular apoptosis (the result of which are shown in FIG. 14).

Cells that were frozen in the cooling devices of the present invention showed greater cell viability than the cells frozen in the Mr. Frosty device. Slight trends towards higher cell viability was observed with faster freezing rates (−1° C./minute and −2° C./minute) when compared to the −0.5° C./minute freezing rate, as shown previously. Caspase 3/7 signal was elevated in all samples at 16 and 40 hours, when compared to the unfrozen cell control. However, a slight trend toward lower apoptosis was observed with faster freezing rates (−1° C./minute and −2° C./minute) when compared to the −0.5° C./minute freezing rate.

Cells frozen in the cooling device can be recovered with greater cell yield and viability. The results from comparing viable cell yield using the cooling unit and a standard passive freezing device (Mr. Frosty, Nalgene) with a human Embryonic Stem Cell (hES) cell line, RC10, demonstrated the cooling device provided twice the viable cell yield and twice the proliferation rate as the Mr. Frosty device.

In accordance with the invention, different cells are best cryopreserved by matching cell type with the cooling rate, and in some embodiments, rates other than the “standard” of 1° C./min are preferred for some cell types. Accordingly, the present invention provides cooling devices that can freeze cells at rates faster and slower than the accepted “standard.” Data for the temperature profiles on the cooling devices with cooling rates of 0.5° C./min and 2° C./min are shown in FIG. 13, along with the standard 1° C./min model. Note the excellent fit of the initial cooling profile to the design specification.

Various cooling devices of the present invention having different cooling rates are constructed in accordance with the invention by altering design variables such as thickness of the insulating material, size of the inner heat sink compartment, and the size of the inner heat sink. Other CoolCell devices with higher cooling rates of 5° C./min, 7° C./min and 9° C./min are made in accordance with the invention by additional design alterations, including use of a metal with a higher thermal conductivity (e.g., aluminum) for the inner heat sink, changes in device geometry, and use other carrier materials (such as solid polypropylene in place of poly-propylene foam) as the insulating material.

Devices in accordance with some embodiments of the present invention were rendered using three-dimensional modeling software and then transferred into a three-dimensional finite element heat transfer program to model device performance. The three-dimensional models where then digitally optimized to achieve the desired geometry and thermal conductivity to meet the cooling rate goal selected. The device was then fabricated using machining capabilities, and the device performance was measured using thermocouples. Illustrative devices include those that show initial cooling rates of 0.5, 1, 2, 5 7 and 9° C./min, all +/−0.25° C./min, when the device is loaded to its capacity with vials containing 1 ml of freezing medium over three consecutive freezing cycles.

The present invention can be practiced using a xeno-free cryoprotectant mixture with minimal or no DMSO that provides a significant increase in recovery of total nucleated cells and CD34⁺ cell yield from cord blood-derived HSCs post thaw. This can improve overall HSC Transplant success rates per unit of cord blood, because total CD34⁺ yield is recognized as a standard predictor of engraftment in HSCT. Furthermore, use of such a CPA avoids the adverse effects of DMSO and associated Dextran 40 wash steps, which result in further reductions in critical CD34⁺ yield per unit cord blood.

Ice formation at any given sub-zero temperature can be reduced by cryoprotective agents such as dimethyl sulfoxide (DMSO), glycerol, ethylene glycol and HES. Although widely used currently in the clinic, 10% DMSO is toxic to human cells and must be removed or greatly reduced in concentration, by Dextran washing before infusion. However, patients still suffer serious adverse reactions either to DMSO or Dextran during HSCT, resulting in additional processing which introduces further process variability. Low molecular weight intracellular cryoprotectants such as DMSO, ethylene glycol and glycerol penetrate the cell membrane and replace intracellular water molecules thereby increasing the cellular osmolality. This reduces the amount of extracellular water molecules that can form ice crystals before reaching the osmotic equilibrium and prevents complete cell dehydration during freezing.

Extracellular cryoprotectors, such as polyvinyl pyrrolidone, HES, polyethylene glycol, dextran, trehalose, and sucrose stabilize the cell by forming a viscous shell around its surface. In some embodiments, the present invention combines intracellular and extracellular cryoprotectors for passive freezing of cell lines derived from cord blood, and hES cell lines H1, H9, Shef 3 and Shef 6 at −80° C. in the devices of the invention.

In some embodiments, hematopoietic stem cells are assayed before and after freezing in the standard CoolCell 1° C./min unit at −80° C. to optimize combinations of CPAs based on viable cell counts, total nucleated cells, CD34⁺ yields and Colony Forming Unit-Granulocyte Macrophage (CFU-GM) content. Previous work with mobilized peripheral blood has indicated that a CPA made of 5% DMSO, 6% HES plus 4% human serum albumin with passive freezing at −80° C. yielded greater CD34⁺ viable cell count post thaw compared to controlled rate freezing in liquid nitrogen with a standard 10% DMSO CPA (McCullough 2010). Total nucleated cells (TNCs) can be enumerated with a hematology analyzer (Coulter Instruments), cell viability by dye exclusion evaluated microscopically using acridine orange and propidium iodide, CFU-GM progenitors can be assayed using a methylcellulose-based assay in growth medium supplemented with growth factors (H4434 Stem Cell Technologies), and CD34⁺ cell counts can be performed with a progenitor cell enumeration kit (Procount, Becton Dickinson). This procedure can be systematically repeated with combinations of various extracellular cryoprotectants including HES, polyethylene glycol, dextran, polyvinyl pyrrolidone, trehalose and sucrose, combined with 0-5% DMSO, to determine the optimal CPA combination that provides the best recovery profile based on the assays described above. This optimized CPA can then be used for further optimization of recovery rates and cell parameters based on differential freezing rate using the devices provided by the invention.

Thus, in some embodiments, the invention is practiced with a xeno-free CPA mixture containing less than 2% DMSO that provides 50% increase in total viable nucleated cells and 40% greater CD34⁺ yield as standard CPAs containing 10% DMSO and 10% FBS for HSCs.

Standard protocols for human stem cell cryopreservation involve slow cooling in the presence of a cryoprotectant to −80° C. at a cooling rate of 1-2° C./min [Berz, 2007]. For clinical applications, the standard method used to cryopreserve umbilical cord blood-derived HSCs and bone marrow-derived stem cells is to use electronically-controlled cooling at 1-2° C./min to −40° C., followed by faster cooling at 3-5° C./min to −120° C., due to the sensitivity of these cell populations to the liberation of the latent hear of fusion [Meryman 1977; Ketheesan 2004]. However, this procedure is labor intensive and requires sophisticated, expensive electronically controlled freezers, a highly-trained technical operator and liquid nitrogen, which is a potential source of contamination (seals leak). Moreover, several reports have now established that passive freezing, in which the specimen is first cooled down to −4° C. and then directly deposited into a freezer at −80° C. or put into liquid nitrogen is safe and has comparable results to the controlled rate process for bone marrow-derived HSCs and peripheral blood-derived stem cells [Cilloni 1999, Halle 2001, Katayama 1997, Perez-Oteyza 1998, Paczkowska 2002, Walter 1999]. Unfortunately, these studies cannot be compared due to differences in procedures used, source of HSCs, nature of the CPA and quality of reagents used (research versus clinical grade). In addition, control of the mechanical freezing process and the temperature of the mechanical freezer have also varied or have not been closely documented nor have variables such as temperature history of the samples, location of the sample in the freezer, and load in the freezer been reported [McCullough 2010, Richer 1993].

Although current cryopreservation protocols have proven to be clinically effective, it is far from clear as to whether they are optimal. This is a particular concern for UCB hematopoietic stem cells for use in allogeneic transplant where harvested volumes are small and the total number of CD34⁺ cells/kg body mass is crucial to successful engraftment in the recipient [Hunt 2011]. In some embodiments, the present invention provides optimized and standardized methods for the isolation of HSCs from UCB for HSCT using a serum-free DMSO-free CPA and a bench-top passive cooling device for cell storage at −80° C.

To quantify the influence of differential cooling rate on post-thaw viability of CD34⁺ hematopoietic stem cells and progenitors after passive freezing of umbilical cord blood (UCB), fresh UCB units can be red blood cell depleted, combined with CPA freezing solution and aliquoted into five 1.5 ml vials, placed into the CoolCell device and placed in a −80° C. freezer. After completion of the freezing process, a portion of the samples are transferred into liquid nitrogen storage and stored for no more than 1 month before analysis and another portion is analyzed immediately after freeze-thaw. The samples are thawed and a portion of the cells seeded into methylcellulose culture and counted after 10 days in culture. Total colony formation is quantified and the number of granulocyte-macrophage colonies enumerated (CFU-GM). The remaining cells are analyzed using flow cytometry, and samples are stained with anti-CD45⁺ and anti-CD34⁺ dyes to assess cell surface phenotype.

The cells are analyzed using the International Society of Hematotherapy and Graft Engineering (ISHAGE) gating protocol. Another portion of the cells are stained with Annexin V and Propidium Iodine to determine the fraction of cells exhibiting apoptosis markers. This process is repeated with a unit of UCB for each differential rate freezing device used (0.5, 1, 2, 5, 7, 9° C./min). Different concentrations of DMSO are used from 0-10% v/v, with different electrolyte solutions (plasma-lyte A, Normosol R), and serum replacement (or human serum albumin) tested to determine optimum composition for the cooling rate used. Additional studies can be performed supplementing the medium with non-reducing sugars (trehalose and sucrose, 0-300 mM concentration) to observe the influence on these additives on post thaw viability.

In accordance with some embodiments of the present invention, the yield of HCS CD34⁺ cells per unit of cord blood can be increased by 80% post freeze-thaw and the total nucelated cells count by 100% compared to standard procedures due to optimized slow cooling protocols in differential freeze devices (0.5, 1, 2, 5, 9° C./min) using a xeno-free DMSO-free CPA, and apoptotic markers can be reduced post thaw by 50% under optimized protocol compared to procedures using passive freezing with standard CPAs.

A major challenge for the widespread application of human Embryonic Stem Cells (hESCs) in clinical therapy and basic scientific research is the development of efficient cryopreservation protocols. Human ESC lines are particularly sensitive to changes in culture conditions and routine passaging and cryopreservation can lead to various degrees of differentiation and loss of pluripotency [Hoffmann 2005; Trounson 2006]. The cryopreservation of hESCs is particularly challenging because these cells are normally passaged and frozen in small colonies rather than as a disaggregated cell suspensions [Ware 2003]. This requires freezing cells at low density which yields poor viability post-thaw. Cell death after thawing is mainly to activation of apoptosis pathways rather than necrosis [Heng 2006].

Currently, there are two methods used for the cryopreservation of hESCs: vitrification and slow freezing-rapid thawing. Slow-freezing allows for lower CPA concentrations and higher cell numbers when cryovials are used when compared to vitrification (0.5-1×10⁶). However, for hES cells grown in feeder layers as discrete colonies, survival rates are very poor-between 5-16% [Reubinoff 2001]. Furthermore, the colonies recovered were undersized compared to typical hES cell colonies and showed a significant degree of differentiation. Zhou [2004] also reported similar results with only slightly higher recovery (approximately 23%). Vitrification, via the open pulled straw method, provides significantly better survival rates of 79-90% [Ruebinoff 2001, Zhou 2004, Hunt 2007, Heng 2005, Li, 2010], but is appropriate only used for small scale hESC preservation due to low numbers of cells that can be frozen per straw. Several other disadvantages limits this approach, including the high concentrations of CPAs needed to obtain the glass-like state are toxic to the cells above 4° C., the method is highly labor intensive and technically difficult, and there is direct contact between liquid nitrogen and the cells presenting a contamination risk.

Recent improvements in slow-freezing protocols for hESCs as an alternative to vitrification have been reported [Ware 2005]. Using dimethyl sulfoxide (DMSO) with fetal bovine serum and ethylene glycol (EG) and a cooling rate between 0.3 and 3° C./min, high rates of hESC survival were reported (80%), but this required an ice nucleation step that is operator dependent and difficult to standardize. A recent report from T'Joen [2011] also found optimal slow-freezing survival rates of hES cell lines by passive freezing at −80° C. using a CPA combination of 5% DMSO and 5% HES (Hydroxy Ethyl Starch), but did not examine the influence of freezing rate. The present invention provides novel CPA and the optimal passive freezing rate in a −80° C. freezer to reproducibly deliver a high recovery ratio of undifferentiated hES cells post-thaw, and enable freezing of large amounts of hESCs for biobanking, while retaining their pluripotency and expansion capacity.

Because hES cells can be grown in large scale culture to generate sufficient cells for multiple analyses, one can optimize hES cells cryopreservation protocols for both CPA combinations and differential freezing rate concurrently. Thus, each hES cell culture will can be divided into aliquots and frozen under different conditions of freezing rate profile and CPA. One can then optimize new CPA combinations using hES cell lines H1 and H9, Shef 3 and Shef 6 in each of the CoolCell devices (0.5, 1, 2, 5 and 7 and 9° C./min). One can optimize an hESC cryopreservation protocol based on some of the key parameters of cell proliferation, function and growth of hES cells, specifically during long term culture post freeze/thaw. At early time points post recovery, one can analyze the rate of cell attachment to coated tissue culture plates using light microscopy, and proliferation rate can be determined by a standard metabolic activity colorimetric assay based on the reduction of Alamar Blue. Viability can be quantified by vital staining with Trypan Blue over a time course of 1, 3 and 5 days post thaw, and will be combined with Propidium Iodide/Annexin V assays to quantify the activation of apoptosis pathways within 1-12 hours post thaw. Late stage apoptosis will be quantified by cleavage of Caspase-3 in fixed and permeabilized cells between 1-5 days post thaw.

One can quantify pluripotency and differentiation status by FACS analysis of cell surface and intracellular markers SSEA-3 and SSEA-4, TRA 1-60, TRA 1-81, Oct4, and ALP, all characteristic of pluripotent hESCs [International 2007]. Another critical QC parameter is karyotype analysis, because there are reports of undifferentiated hES cells undergoing culture adaptation at high passage number (over passage 15) involving karyotypic and genotypic changes (Baker 2007, Lefort 2009). In some embodiments, this is of critical importance to the safety of subsequent clinical use, because genomic rearrangements (most commonly, duplication of chromosomes 12, 17 or X) can result in faster doubling times and could promote tumorigenesis.

Thus, some embodiments of the present invention provide standardize protocols for cryopreservation of hESCs—adherent as well as colony-forming cell lines—that will yield greater than 90% viability and result in less than 2% differentiated cells upon recovery and extended culture (>passage 10). After prolonged culture post thaw, expression levels of Oct4 and Nanog can be determined by qPCR and are desirably equal to pre-freeze levels. Similarly, expression of mesodermal, endodermal and ectodermal markers equivalent to levels detected prior to freezing will indicate a pluripotent and differentiation potential equal to pre-freeze cells. Desirably, apoptosis levels are below 5% of total cell count during extended culture, versus 20-30% reported recently [Xu 2009], and no gross chromosomal rearrangement is detected by karyotype analysis. Optimized CP protocols resulting in hESC cultures with these characteristics in combination with xeno-free and DMSO-free CPAs will facilitate expanded use in a wide variety of current and future cell therapy applications.

### III. Static Cooling Devices

In some aspects of the present invention, freezing or cooling devices are provided that are configured to achieve a constant, controlled cooling rate when placed in a −80° C. freezer or dry ice. In some embodiments, a cooling rate of other than 1° C./minute is achieved. In other embodiments, a cooling device is provided which comprises a cooling rate of 2° C./minute. Further, in other embodiments a cooling device is provided which comprises a cooling rate of 0.5° C./minute.

In various embodiments, the freezing device comprises a base that is made of an insulating material (e.g., a cross-linked high-density polyethylene foam) that surrounds a cluster of vessels comprising samples, and a cover that is also made from an insulating material and that interlocks with the base to form a cooling chamber. The vessels are positioned in a circular array of vessel chambers within the base, or in a removable rack that is positioned onto the base. The samples are cooled by thermal energy extraction from the samples and vessel surfaces through the insulating material, or through a plurality of vent openings.

To achieve a particular cooling rate, one selects a set of design variables of the freezing device that provides the desired cooling rate. These variables are the thickness of the insulating material at various places of the freezing device (e.g., the outer rim of the base, the outer rim of the inner heat sink compartment, the thickness of the cover, and the thickness of the floor of the base), the diameter of the base and/or the inner heat sink compartment, the device geometry, the number of vessel chambers, the number of sample vials contained within the freezing device, the sample mass contained within the sample vials, the presence or absence of a solid core in the inner heat sink compartment, the mass or composition of the solid core in the inner heat sink compartment, the composition of the insulating material, and the size of the ventilation holes.

In various embodiments, a desired cooling rate is achieved by selecting an appropriate (i) thickness of the insulating material in the base and/or the cover; (ii) size and/or number of one or more ventilation holes; (iii) diameter of the inner heat sink compartment; (iv) volume of the solid core in the inner heat sink compartment (v) insulating material in the base or cover or both with respect to thermal conductivity; and (vi) size of the vessel/vessel chambers and/or vessel liquid loads.

With the number of physical parameters that have an influence on the freezing rate of a freezing device of the invention, it can be understood that a freezing device that provides a specific cooling rate can be readily constructed using any of a wide variety of combinations of the variable elements. A method for determining an effective combination of variable elements can be determined in accordance with the invention by selecting static values for some elements and then adjusting one or more of the remaining elements. By way of example, if one selects a cylindrical freezing device with a radial array of sample vial distribution, and one desires a freezing device with a cooling rate of 1.5° C. per minute, the design could begin by selecting four pound per cubic foot cross-linked polyethylene foam for the insulation material, as the performance parameters of this material is well known. The sample vial load is fixed at 1 ml per vial (a common freezing volume used in the scientific community). The vial capacity of the device is set at six to allow for diametric material removal.

The sample vial layout may be arranged such that the vials are upright and in a radial pattern with a device axis to vial chamber axis distance such that the minimum inter vial chamber wall thickness is not less than 0.12 inches and preferably not less than 1.4 inches, so that the foam material can be machined without concern for thin wall distortion or vibration. For the same reason, the inner chamber diameter is limited to a maximum that would provides a minimum central chamber wall to vial chamber wall thickness of not less than 0.12 inches and preferably not less than 1.4 inches. A foam cylinder (the device base) with a height equivalent to that of the intended sample vial height plus one inch, and an outside diameter equal to not less than 5.5 inches is prepared. A cylindrical lid with a diameter equivalent to the diameter of the cylindrical base and a height of 1 inch, with an attached concentric cylindrical extension of the same material on one end face, with a height of not less than 0.25 inches and not more than 0.4 inches and a diameter equivalent to the central chamber diameter of the base is then prepared to act as a cover for the base and to interface with the central cavity. A thermoconductive core is constructed in a cylindrical configuration with an outside diameter equivalent to the diameter of the central foam chamber minus approximately 0.05 inches to allow for the differential thermal expansion coefficients of the two materials. The height and inner diameter of the cylindrical core can be selected such that the core has a mass of 30 grams. At least one access port hole is introduced through the lid through which a thermocouple probe wire could be passed, such the probe wire would exit the lid at a position coaxial to the axis of a sample vial resting in a base chamber hole.

In some instances, a test may be conducted by placing a sample vial with a 1 ml load of freezing media each into each sample vial chamber of the base for a total of 6 vials. A minimum of one of the six vials is equipped with a thermocouple temperature sensor for measuring the temperature of the vial contents during a test freezing cycle by introducing an access hole for the thermocouple sensor wire in the cap of the test sample vial. The thermoconductive core component is then inserted into the central chamber and the lid carefully lowered onto the base component while adjusting the thermocouple wire in the lid such that the probe wire is not bent between the vial and the lid underside. A temperature recording device is then attached to the thermocouple wire, and the base, vial, core and lid assembly are transferred to a −75° C. freezer chamber with the thermocouple probe leading through the freezer door seal the temperature recorder at the freezer exterior. After a period of 4 hours, the temperature recorder is then stopped and the device assembly removed from the freezer. The temperature versus time profile is then constructed from the data, and the cooling rate determined according to the formula above.

If the desired cooling rate is not achieved, then the diameter of the base and lid components can be reduced by 0.25 inches and the freezing experiment repeated. The increase in the cooling rate can be evaluated against the decrease in the diameter, and an estimate made of the approximate diameter that would coincide with a freezing rate of 1.5° C. per minute. The diameter of the base and lid can be further reduced to a value that is half way between the current value and the value estimated to provide the desired cooling rate. The freezing experiment can then be repeated and the diameter of the lid and base reduced in an iterative process until the desired cooling rate is obtained. As the cooling rate approaches the desired target cooling rate, the cooling rate can also be increased by removing material from the inside of the core cylinder leaving the outside diameter unaltered. Alternatively the cooling rate can be decreased by replacing the core with a core with a smaller center hole.

In some embodiments, the freezing or cooling device achieves a cooling rate of 2° C./minute for twelve 2 mL serum vials with a 1 mL liquid load each. In other embodiments, the freezing device achieves a cooling rate of 0.5° C./minute for twelve 2 mL serum vials with a 1 mL liquid load each. In some embodiments, the freezing device has a capacity of no more than 6 vials, no more than 5 vials, no more than 4 vials, no more than 3 vials, no more than 2 vials, or no more than 1 vial.

In other embodiments, the present invention provides a kit comprising multiple different freezing devices, wherein each different freezing device provides a different cooling rate. In some embodiments, the kit comprises a first, second, and third freezing device, wherein the first, second, and third freezing device each has a capacity for no more than 3 vessels, and wherein when placed in a −80° C. freezer or dry ice, the first freezing device achieves a cooling rate of 0.5° C./minute, the second freezing device achieves a cooling rate of 1° C./minute, and the third freezing device achieves a cooling rate of 2° C./minute.

### IV. Programmable Freezing Devices

In some embodiments, the present invention provides freezing devices that can provide any of a variety of different controlled cooling rates as selected by the user of the device and so are referred to as “programmable freezing devices”. In some instances, the freezing or cooling device provides programmable cell freezing and thawing, including different cooling rates ranging from 0.01° C. per minute to 3° C. per minute. In some embodiments, all of the vials or other sample containers (e.g. well in a multi-well plate) in the device are cooled (or thawed or both) at the same rate. In other embodiments, different vials or sample containers in the device are cooled (or thawed or both) at different rates. The cooling rate can be programmed to be constant or variable. The device can be operated in a multi-well format, in which either a microtiter (96 well) plate or other multi-well plate is placed in the device, and the device is operated in any of a variety of formats selected by the user. In some instances, different cooling and/or thawing rates are tested in a multi-well format simultaneously (i.e., one or more wells are tested at one rate while other wells are tested at another rate simultaneously). In other instances, the device is equipped to provide a read-out for cell viability (e.g., based on a colorimetric assay using a reagent such as trypan blue or alamar blue) or cell function.

In some embodiments, the present invention comprises a benchtop programmable cooling device that is configured to freeze cell monolayers while maintaining high cell viability. In some instances, the benchtop programmable cooling device utilizes dry ice and a low voltage Peltier chip to achieve accurate and repeatable cooling profiles. In some embodiments, a benchtop programmable cooling device is provided that comprises a fixed cooling rate of −1° C./min. In other embodiments, a benchtop programmable cooling device is provided which is capable of being programmed to freeze cell monolayers at variable cooling rates. Further, in some embodiments a benchtop cooling device is provided that is configured to provide programmable freezing profiles for multiple vessel formats and variable payloads of cell suspensions. A benchtop cooling device may be provided which is low cost, lightweight, highly reliable and robust. In some instances, a benchtop cooling device is provided which comprises high heat absorption capacity with no moving parts.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A method for determining an optimal cooling rate for cryopreservation of a cell, said method comprising cooling to −75° C. multiple samples of said cell at different cooling rates and identifying the cooling rate the provides the highest viability of said sample after said samples have been maintained at −75° C. for at least ten minutes.

2. A method for cryopreservation of a cell, said method comprising cooling said cell from a temperature of at least 20° C. to a temperature of −75° C. at a rate of less than 10° C. per minute but greater than 1° C. per minute.

3. The method of claim 2, wherein said rate is −2° C. per minute.

4. A method for cryopreservation of a cell, said method comprising cooling said cell from a temperature of at least 20° C. to a temperature of −75° C. at a rate of less than 1° C. per minute.

5. The method of claim 4, wherein said rate is −0.5° C. per minute.

6. (canceled)

7. (canceled)
